(19) United States
(12) Patent Application Publication
(10) Pub. No.: US 2013/0199997 A1
(43) Pub. Date: Aug. 8, 2013

(54) Method of Treating Municipal Wastewater and Producing Biomass with Biopolymer Production Potential

(71) Applicants: Alan Gideon Werker, Lomma (SE); Simon Olof Harald Bengtsson, Dalby (SE); Elise Marie Blanchet, Poissy (FR); Maria das Dores Tavares Gurgo e Cirne, Maisons Laffitte (FR); Carl Anton Börje Karlsson, Lund (SE); Fernando Morgan-Sagastume, Malmo (SE)

(72) Inventors: Alan Gideon Werker, Lomma (SE); Simon Olof Harald Bengtsson, Dalby (SE); Elise Marie Blanchet, Poissy (FR); Maria das Dores Tavares Gurgo e Cirne, Maisons Laffitte (FR); Carl Anton Börje Karlsson, Lund (SE); Fernando Morgan-Sagastume, Malmo (SE)

(73) Assignee: VEOLIA WATER SOLUTIONS & TECHNOLOGIES SUPPORT, Saint-Maurice (FR)

(21) Appl. No.: 13/817,021

(22) PCT Filed: Aug. 17, 2011
(86) PCT No.: PCT/IB11/53640

§ 371 Date: Apr. 24, 2013

Related U.S. Application Data
(60) Provisional application No. 61/374,693, filed on Aug. 18, 2010.

(51) Int. Cl. C02F 3/12

(52) U.S. Cl. CPC C02F 3/1221
USPC 210/614; 210/620; 210/630; 210/626

(57) ABSTRACT

A method of biologically treating wastewater and removing contaminants from the wastewater is disclosed. In the course of treating the wastewater, biomass is produced. In addition to removing contaminants from the wastewater, the process or method of the present invention entails enhancing the PHA accumulation potential of the biomass. Disclosed are a number of processes that are employed in a biological wastewater treatment system for enhancing PHA accumulation potential. For example, enhanced PHA accumulation potential is realized by exposing the biomass to feast and famine conditions and, after exposing the biomass to famine conditions, stimulating the biomass into a period of feast by exposing the biomass to feast conditions for a selected period of time by applying an average peak stimulating RBCOD feeding rate of greater than 5 mg-COD\L\MIN in combination with an average peak specific RBCOD feeding rate greater than 0.5 mg-COD\g-VSS\MIN. In another example, the PHA accumulation potential of the biomass is enhanced by subjecting the biomass to feast conditions that cause the biomass to reach a peak respiration rate that is at least 40% of the extant maximum respiration rate of the biomass. Other processes are discussed that can contribute to enhancing PHA accumulation potential of biomass.

### FIELD OF THE INVENTION

The present invention relates to a biological wastewater treatment system and process and, more particularly, to a biological wastewater treatment system and process that produces biomass capable of accumulating polyhydroxyalkanoates (PHAs).

### BACKGROUND OF THE INVENTION

Domestic wastewater is principally derived from residential areas and commercial districts. Institutional and recreational facilities also represent sources contributing to this wastewater. The organic content of domestic wastewater, after primary sedimentation, is often times low ranging from 100 to 900 and certainly under 1000 mg-COD/L. Where higher strength municipal wastewaters are encountered, the municipal treatment facilities are likely to be receiving domestic wastewater plus additional organic loading from industrial activity in the region.

A significant fraction of the primary treated wastewater organic content is not dissolved and is thereby considered to be particulate in nature. The dissolved fraction of primary effluent usually contains readily biodegradable chemical oxygen demand (RBCOD). Some of the particulate fraction, given sufficient time in a biologically active environment, also becomes hydrolyzed to RBCOD.

Biological removal of the chemical oxygen demand (COD) in municipal wastewater produces a biomass and wasted biomass has become a solid waste disposal problem around the world. The state-of-the-art method to mitigate the amount of biomass requiring disposal is with anaerobic digestion of the biomass to produce a biogas that can be converted to a source of energy.

Much time and effort has been spent by scientists and researchers attempting to identify valuable and worthwhile uses of biomass produced in the course of biologically-treating wastewater. It is known that biomass produced in wastewater treatment has the potential to accumulate PHA. PHAs are biopolymers that can be recovered from biomass and converted into biodegradable plastics of commercial value which can be employed in many interesting and practical applications.

Ordinary biological wastewater treatment processes produce biomass and the produced biomass usually includes some potential to accumulate minimal levels of PHA. However, these potential levels of PHA are insufficient to make harvesting biomass and extracting PHAs therefrom economically feasible.

Therefore, there is a need for a biological wastewater treatment system and process that not only removes contaminants from the wastewater but also aims to produce a biomass having enhanced potential for accumulating PHA.

### SUMMARY OF THE INVENTION

The present invention relates to a method of biologically treating wastewater and removing contaminants from the wastewater. In the course of treating the wastewater, biomass is produced. In addition to removing contaminants from the wastewater, the process or method of the present invention entails enhancing the PHA accumulation potential (PAP) of the biomass.

Discussed herein are a number of processes that can be employed in the biological wastewater treatment system to enhance PAP. For example, enhanced PHA accumulation potential can be realized by exposing the biomass to feast and famine conditions and, after exposing the biomass to famine conditions, stimulating the biomass into a period of feast by exposing the biomass to feast conditions for a selected period of time by applying an average peak stimulating RBCOD feeding rate of greater than 5 mg-COD\L\MIN in combination with an average peak specific RBCOD feeding rate greater than 0.5 mg-COD\g-VSS\MIN. In another example, the PHA accumulation potential of biomass is enhanced by subjecting the biomass to feast conditions that cause the biomass to reach a peak respiration rate that is greater than 40% of the extant maximum respiration rate of the biomass. Other processes or steps are discussed herein that can contribute to enhancing the PHA accumulation potential of biomass. For example, controlling or manipulating the RBCOD volumetric organic loading rate subjected to the biomass can impact the ability of the biomass to accumulate PHA. In addition, in biological wastewater treatment processes, thickened biomass mixed liquor is typically recycled and mixed with fresh influent wastewater. The volumetric recycling rate of the biomass mixed liquor can also play a significant role in enhancing the PHA accumulation potential of the biomass. Another example of a process parameter that can contribute to enhancing PHA accumulation potential of the biomass is to maintain a relatively short solids residence time. These and other discoveries that can be employed to enhance PHA accumulation potential in biomass are discussed in more detail herein.

### BRIEF DESCRIPTION OF THE DRAWINGS

FIG. 1 is a schematic diagram of a biological wastewater treatment system that is designed to enhance the PHA accumulation potential of biomass produced.

FIG. 2 shows two highly magnified images of the same biomass but wherein the image on the right has been subjected to Nile blue staining which indicates that a large fraction of the bacteria in the biomass has capacity to store PHA.

FIG. 3 is a graph indicating PHA content in a biomass sampled over a period of time at two different locations in the wastewater treatment system shown in FIG. 1.

FIG. 4 is a graph that plots fraction of biomass as PHA vs. accumulation time and which generally depicts that accumulation of PHA using a fermented dairy industry effluent in a pilot scale fed batch reactor with respiration based on feed-on-demand control.

FIG. 5 is a graph showing fraction biomass PHA content vs. accumulation time and which shows the results of biomass having a typically low PAP used to inoculate laboratory-scale bioreactors.

FIG. 6 is a graph showing the induced specific oxygen uptake rate (SOURᵢ) as a function of RBCOD-acetate concentration for three sources of activated sludge mixed liquor representing a range of PAP from low, to medium, and to medium-high levels of PAP.

FIG. 7 is a graph showing the induced specific oxygen uptake rates (SOURᵢ) as a function of influent wastewater to mixed liquor mixing ratio for activated sludge acclimated with respective municipal wastewaters.

FIG. 8 is a schematic illustration of an activated sludge process that treats RBCOD and which employs basic principles to enhance the PHA accumulation potential of biomass produced in the process.

FIG. 9 is a schematic illustration of a biological wastewater treatment process employing a biofilm process for treating RBCOD and wherein the process employs principles for enhancing the PHA accumulation potential of the biomass produced.

FIGS. 10A and 10B are schematic illustrations of biological wastewater treatment processes applying the principles of the present invention relating to enhancing PHA accumulation potential in biomass for the case of a semi-continuous influent flow suspended biomass growth process for treating RBCOD in the wastewater.

FIG. 11 is a schematic illustrating an overall process scheme for biomass-with-PAP production using municipal wastewater and including advanced primary treatment.

FIG. 12 is a schematic illustration of an overall process scheme for biomass-with-PAP production using municipal wastewater and applying the technique of contact stabilization to remove colloidal organic matter during high rate RBCOD removal.

### DETAILED DESCRIPTION OF THE INVENTION

Municipal wastewaters directed towards biological treatment typically comprise suspended and dissolved organic matter. The dissolved fraction of the organic matter is usually biologically degradable with a concentration often not more than 500 mg-COD/L. A large fraction of this COD (chemical oxygen demand) may be considered to be readily biodegradable (RBCOD). The process of the present invention concerns the production of a biomass from the treatment of municipal wastewater RBCOD wherein the biomass produced exhibits an enhanced potential for accumulation of PHA. As noted earlier, PHA is a biopolymer that can be recovered from biomass and converted into biodegradable plastics of commercial value due to many interesting practical application areas. The enhanced potential for accumulation of PHA refers to the capacity of the biomass to store PHA in excess of 35%, and preferably in excess of 50%, of final organic weight as PHA when the biomass is fed, in a separate process and in a controlled manner, other available sources of RBCOD. The biomass concentration in a mixed liquor of suspended growth systems is often assessed by well-established methods as total suspended solids (TSS) and the organic component of the biomass as volatile suspended solids (VSS). Thus, the PHA level in activated sludge may be expressed as g-PHA/g-TSS but more preferably as g-PHA/g-VSS. If, for example, the ash content of an activated sludge biomass is 10%, then by applying the methods of the present invention a PHA accumulation potential (PAP) in excess of approximately 32% g-PHA/g-TSS, and preferably in excess of 45% g-PHA/g-TSS will be achieved.

One method of encouraging PAP in biomass is by exposing the biomass to distinct cycles of feast and famine conditions. Essentially, exposing the biomass to feast and famine conditions entails exposing the biomass to dynamic conditions of organic carbon substrate supply. Under these conditions, organic carbon substrates are supplied in such a way as to promote alternating periods of substantial substrate availability (feast conditions) and periods of substrate deficiency (famine conditions). Under feast conditions, the biomass takes up RBCOD and stores a substantial fraction of them in the form of PHA for subsequent utilization for growth and maintenance under famine conditions. This storage and utilization of PHA is a turnover of PHA as a result of the feast and famine cycling to which the biomass is repeatedly exposed to. Notwithstanding the enrichment of biomass with PAP, the measurable PHA levels in the biomass during wastewater treatment may only be a minor fraction of the full extant biomass PHA accumulation potential.

RBCOD in the wastewater is consumed by the biomass under conditions of feast. As a result of the biomass consuming RBCOD under feast conditions, the wastewater is effectively treated as the RBCOD concentration of the wastewater is reduced. In order to achieve feast conditions for the biomass, the influent RBCOD is combined with the biomass suspended or as a biofilm in a mixed liquor in such a way as to expose the biomass to a sufficiently high RBCOD concentration at some point. A selective pressure for enhancing for PAP in the biomass is imposed if peak stimulating feast RBCOD conditions subsequent to famine are applied repeatedly and are achieved on average. The average peak feast stimulating concentration should be in excess of 10 mg-RBCOD/L but preferably in excess of 100 mg-RBCOD/L while maintaining the overall wastewater contaminant concentrations to levels less than that determined to be inhibiting to the biomass. The term “peak concentration” means the maximum RBCOD concentration in a feast zone during a selected time period. The average peak concentration is determined by averaging the peak concentrations over a certain number of time periods. If primary or advanced primary treatment is applied to the influent wastewater then the primary solids may be fermented in a side-stream and the RBCOD thereby released by this fermentation step can be used to supplement the feast response.

Famine conditions for the biomass may be achieved in a side-stream to the main wastewater flow whereby PHA stored in the biomass from RBCOD consumption during feast is itself at least in part consumed while the biomass is brought to an environment of negligible available RBCOD. Biomass produced with enhanced PAP is harvested from the wastewater treatment process and directed to a waste sludge handling process. In the trade, this biomass harvesting is referred to as “wasting” and for activated sludge processes it is called waste activated sludge. For present purposes and as part of our waste sludge management practices for the objectives of this invention, this wasted biomass is made to accumulate PHA, preferably to the extent of its potential, and this accumulated PHA is subsequently recovered as a value added product. Sludge handling with PHA accumulation and recovery presents alternate opportunities to significantly reduce the final mass of waste sludge residuals requiring disposal.

The present invention concerns a method or process of enrichment and production of PHA producing biomass as a result of the treatment of municipal wastewater. The concentration of organic contaminants in wastewater are often assessed in terms of chemical oxygen demand (COD). A higher COD reflects a higher level of organic contamination in the wastewater. The objective of the present invention is to utilize the low concentrations of soluble readily biodegradable chemical oxygen demand (RBCOD) in such wastewater in order to stimulate PHA metabolic turnover in the biomass during the wastewater treatment. In so doing, it is possible to enrich the biomass with PHA-producing potential as well as to improve PHA accumulation kinetics to levels that are significantly higher than those that would normally be anticipated for biomass produced from organic carbon removal from municipal wastewater treatment today. The biomass harvested from the municipal wastewater treatment process can thereby be harnessed to produce biopolymers given the availability of other organic feed stocks that may be more specifically required to produce a particular kind of PHA.

In one embodiment the method exploits the harvested wastewater treatment biomass for accumulation of PHA biopolymers in amounts and rates that become more commercially interesting. The economic viability of PHA accumulation and recovery is improved by:
1. Encouraging the growth of biomass that exhibits enhanced capacity for PHA accumulation potential. The greater the PHA content that can be reached in the harvested biomass, the more productive and effective will be the PHA purification process. More PHA will be recovered per unit extraction volume. Experience indicates that the extraction efficiency increases with extent of PHA accumulated in the biomass.
2. Manipulating the PHA accumulation rate of the biomass such that the maximum capacity for the PHA accumulation can be achieved in a relatively short time frame. The greater the kinetics of PHA accumulation the more productive and effective will be the accumulation unit process. More PHA may be produced per unit volume for a give time.

The present invention addresses both of these factors towards an overall means to achieve an increasingly more practical and economically viable infrastructure for production processes for biopolymers that are directly coupled to services of wastewater amelioration (See Examples 11 and 12). Successful practical solutions for biopolymer production, from biomass treating municipal wastewater, are desirable because they may lead in parallel to methods for reduction of waste sludge requiring disposal. Problems associated with disposal of sludge emanating from municipal treatment works are acknowledged globally by governmental organizations and specialists in the water industry around the world.

The organic carbon sources supplied with goals of biomass-with-PAP production or for goals of subsequent PHA accumulation and recovery need to be considered independently from one and another. It has become common in academic research focused on mixed cultures of biomass enriched for PHA production that volatile fatty acids (VFAs) are used as the principal organic carbon source for both the biomass production and the PHA accumulation processes. VFAs are an example of RBCOD and are the most frequently applied RBCOD for scientific investigations concerning fundamental developments for enrichment biomass production and PHA accumulation in mixed culture systems such as activated sludge. However, in practical applications, the process for converting COD into VFAs may necessitate fermentation unit processes that add capital and operation costs to the process. VFAs are acids and so fermentation unit processes may well require expensive chemical additions in order to control the fermented wastewater pH. Municipal wastewater treatment plants process daily large volumes of low strength wastewater. Thus a mainstream fermentation process may not be economically attractive if additional large reactor volumes are needed in order to achieve the retention times necessary for conversion of wastewater COD into VFAs. Therefore, while VFAs may be considered to be important and often a principal RBCOD source used for the actual PHA accumulation step, it may be of practical and economic advantage if one can rather produce the biomass required for subsequent PHA accumulation without dependence on RBCOD as VFA. Ideally, one would like to exploit the influent soluble organic matter for the biomass-with-PAP production with little if any burden of intervening pretreatment steps.

Explicit application of the presented method or process significantly improves the economic viability of PHA production from biomass used to treat municipal wastewater. In extension, the implementation of this invention can be used to further develop municipal wastewater treatment infrastructure and in so doing achieve further progress towards a long-standing objective of lower overall sludge production.

The process of the present invention concerns a more selective production of biomass from organic carbon removal from municipal wastewater. The biomass is enhanced with the functional attribute of PHA accumulation potential. One objective is towards achieving PAP for purposes of the exploitation of this accumulation potential in commercially viable processes that enable production and recovery of PHA as a value added product. The process steps of PHA production and recovery may further serve towards energy production and mitigating waste biomass disposal.

The problem is to address known practical limitations to this objective; the levels of PAP in open mixed cultures that have been obtained when treating municipal wastewater have hitherto been considered in general to be insufficient and the kinetics of accumulation have been found to be slow. Strategies to overcome these limitations were developed and involve:
Exposing the biomass to dynamic conditions with respect to RBCOD supply.
Defining the conditions of RBCOD organic loading for the biomass with respect to amount, concentration, rate, time and/or location in the process.
Enhancing the biomass for PAP using RBCOD sources not limited to be volatile fatty acids (VFAs) and alcohols.
Increasing the yield of biomass by applying a low sludge residence time.
Establishing flexibility to adapt the process to existing treatment infrastructure operating in continuous or sequencing batch reactor configurations.
Establishing flexibility to adapt the process to existing treatment infrastructure operating with biomass produced in suspensions (i.e. activated sludge) or in biofilms (i.e. rotating biological contactor or moving bed bioreactor).

Activated sludge is a widely used process for biological wastewater treatment. It is known that species of bacteria present in the biomass of activated sludge are able to produce PHA. PHA production by these bacteria entails the uptake, conversion, and storage of wastewater organic matter as PHA. This metabolic process is well-known in activated sludge and included in state-of-the-art process models. Nevertheless, to date, the reported potential to accumulate PHA is low for activated sludge used in general to treat low organic strength municipal wastewater. This low accumulation potential is relative to the potential of activated sludge that has been made to be enriched for PAP using higher strength industrial wastewaters with RBCOD comprised to a significant fraction with VFA. For activated sludge treating municipal wastewater, a maximum content of 30% g-PHA/g-TSS has been reported in batch PHA accumulation tests with 18 activated sludge samples from 4 different municipal wastewater treatment plants in Japan (Takabatake H, Satoh H, Mino T, Matsuo T. 2002. PHA (polyhydroxyalkanoate) production potential of activated sludge treating wastewater. Water Science and Technology 45(12):119-126). Similarly, a content of approximately 20% g-PHA/g-TSS was obtained when municipal wastewater was treated in lab-scale reactors operated under alternating anaerobic-aerobic conditions, known to favor the proliferation of PHA-producing microorganisms (Chua ASM, Takabatake H, Satoh H, Mino T. 2003. Production of polyhydroxyalkanoates (PHA) by activated sludge treating municipal wastewater: effect of pH, sludge retention time (SRT), and acetate concentration in influent. Water Research 37(15):3602-3611).

The PHA content of the dry biomass is an important technical and economic factor in the commercial production of PHA since it impacts on the efficiency of polymer recovery in downstream processing, and on the overall polymer yield with respect to consumed RBCOD. In addition, a higher rate of PHA accumulation positively influences the process volumetric productivity. Therefore, it is preferable to choose conditions towards stimulating the PAP enhancement of the activated sludge that promote both a superior accumulation rate and an improved PHA accumulation capacity of the biomass. It is advantageous to achieve these goals of enrichment in direct coupling to requirements for treating the wastewater.

It has been discovered that with due attention paid to RBCOD loading, sludge retention time, and feast-famine stimulation, that a municipal biological treatment process can be operated to produce an activated sludge biomass that accumulated PHA in the range of 37 (33) to 51 (46) % g-PHA/g-VSS (TSS) in 24-hour batch accumulation experiments (Example 1 to Example 3). In addition, it was surprisingly found that biological treatment of low strength municipal wastewater containing RBCOD with negligible VFA and alcohol content, may facilitate the enhancement of biomass-with-PAP.

As discussed above, the feast and famine conditions can be imposed on the biomass as a function of time or location in the process but also due to the daily influent variation of organic loading rate over time such that in both cases an activated sludge or biofilm biomass experiences, on average, recurring periods of higher RBCOD supply alternating with periods of less RBCOD supply. What has not been previously well-defined in the research and patent literature are the operational criteria to be applied for feast conditions involving municipal wastewaters where RBCOD may be difficult and expensive to routinely characterize, and where the RBCOD is often present with unreliable levels of VFA and alcohol content.

VFAs are favorable substrates for PHA production. This type of RBCOD has been considered as a principal group of organic compounds that are converted into PHA by mixed microbial cultures such as activated sludge. In addition, the scientific literature has revealed that suitably acclimated mixed cultures are able to convert alcohols into PHA (Beccari M, Bertin L, Dionisi D, Fava F, Lampis S, Majone M, Valentino F, Vallini G, Villano M. 2009. Exploiting olive oil mill effluents as a renewable resource for production of biodegradable polymers through a combined anaerobic-aerobic process. Journal of Chemical Technology and Biotechnology 84(6):901-908). The fraction of VFA and alcohols in the RBCOD of municipal wastewater may often be variable and with moderate to very low (<10-30 mg-COD/L) concentrations, and these low concentrations have been seen as a technical obstacle towards enriching PHA-producing potential from activated sludge wasted from municipal wastewater biological treatment facilities (Chua et al., 2003).

Further since the chemical composition of RBCOD directed to municipal wastewater treatment facilities is not specifically controlled, it is a practical advantage to be able to design a process for biomass-with-PAP production that is insensitive to the type of RBCOD arriving in the influent. To this end, it has been discovered that RBCOD in general and more specifically RBCOD containing negligible amounts of VFA and alcohols can be made to contribute to the biomass PHA storage response. This finding means that biomass-with-PAP enhancement can be achieved as a by-product of the wastewater biological treatment services (Example 1). With attention paid to process design for organic loading and feast simulating conditions, biological treatment of municipal wastewater RBCOD can be exploited to produce a biomass with both enhanced PAP and accumulation kinetics (Example 5). Municipal wastewater treatment plants may in this way be operated for pollution control and as a source of a functional biomass that facilitates in parallel PHA production and an alternative attractive strategy for residual sludge management.

Municipal wastewater RBCOD organic loading rate in combination with low sludge retention time (SRT) will stimulate PAP enhancement in activated sludge for RBCOD that does not contain a significant level of VFAs or alcohols. In addition findings suggest that the method of application of feast with RBCOD is significant towards conditioning increased extant PHA accumulation kinetics in the biomass (Example 5). To this end it is preferred to induce higher extant biomass feast respiration rates in the mixing of influent wastewater containing RBCOD with biomass disposed from famine conditions. An objective of the biomass loading for feast is to stimulate metabolism of PHA turnover. A feast response for PHA accumulation is stimulated if the biomass is induced by a sufficiently high concentration of RBCOD. A lower threshold for such stimulation is readily determined by simple standard methods for measuring the biomass oxygen uptake rate (Example 6 and Example 7). Following such established methods (Archibald F, Methot M, Young F, and Paice M. 2001. A simple system to rapidly monitor activated sludge health and performance, Wat. Res. 35(19):2543-2553), it was observed with reference RBCOD that significant feast stimulation is achieved by approximately 10 mg-COD/L. The respiration rate of biomass will increase with increased RBCOD concentration up to a maximum limit. This maximum limit for the biomass respiration response can vary but generally it was observed that a respiration capacity was reached with an RBCOD concentration of approximately 100 mg-COD/L and above. It was also observed that with increased PAP, the respiration rate capacity of the biomass is typically higher.

Monitoring to ensure an inducing feast RBCOD concentration of at least 10 mg-COD/L may not be simple in routine process operations. RBCOD is rapidly biodegraded and so reliable sampling, preservation and analysis for quantification of RBCOD in the feast environment is challenging. Nevertheless, where the average influent wastewater RBCOD concentrations are characterized, the feast stimulating conditions can be established in the process design by ensuring a minimum specific feeding rate to the biomass directed from famine conditions to the zone of feast conditions. The feast stimulating feeding rate is estimated by the influent RBCOD mass flow rate (mg-COD/min) divided by the volume of the process feast zone (mg-COD/L/min). The specific stimulating feeding rate is estimated by the influent RBCOD mass flow rate divided by the mass of biomass in the process feast zone (mg-COD/g-VSS/min). The terms “average peak feeding rate” or “average peak feast stimulating RBCOD feeding rate” are used herein. “Peak feeding rate” means the maximum feeding rate that the biomass is subjected to during one period of exposure to feast conditions. Since the biomass is subjected to alternating feast and famine conditions, it follows that the biomass is exposed to numerous separate periods of feast conditions. The average peak feeding rate is an average of the peak feeding rates for the various periods where or when the biomass is subjected to feast conditions.

It has been found that an average stimulating feast RBCOD feeding rate of 8 mg-COD/L/min resulting in a specific RBCOD feeding rate of 0.5 mg-COD/g-VSS/min was sufficient to enhance for PAP (Example 5).

RBCOD concentration or specific feeding rate provide criteria with which to establish design and operating conditions to ensure, at least on average, a sufficient feast response in the biomass. In the field, however, it may be more preferable to assess the respiration rate induced in the biomass when stimulated into feast with the influent wastewater. The respiration rate assessment is used to establish the process control based on the extant capacity of the biomass respiration that is being stimulated (Example 6 and Example 7). Biomass in the process is stimulated into feast respiration after being subjected to conditions of famine. For example, biomass that has been separated and concentrated from the treated effluent, are recycled, given a sufficient exposure of famine, to the feast zone. The initial mixing of influent wastewater with the recycled mixed liquor containing biomass dilutes the influent RBCOD concentration. The wastewater influent volumetric flow rate divided by the recycle mixed liquor volumetric flow rate defines a mixing ratio from which the feast RBCOD concentration, to which the biomass are initially exposed to, may be estimated. Alternatively one may establish from direct measurements the fraction of the biomass respiration capacity that is achieved for a given mixing ratio (Example 7).

Some wastewaters may contain substances inhibiting to the biomass. Therefore, the RBCOD stimulating concentrations cannot be made in absence of consideration for other wastewater contaminants that may negatively influence the biomass health if these substances are allowed to be present at higher concentration (Example 7). Higher influent wastewater to recycle biomass volumetric mixing ratios are not necessarily better. It is therefore of interest to proactively protect the process from shock loading and process upset conditions due to, for example, unusual influent events. Influent quality of RBCOD may change daily or seasonally. Therefore, it is preferable that the influence of the influent mixing dilution, on the biomass bringing optimal settings for feast stimulation, be assessed routinely from grab sample investigations or, more preferably, by means of on-line monitoring. On-line monitoring of the influent wastewater quality and strength can be achieved, for example, by commercially available instruments employing scanning spectroscopy. For aerobic feast conditions, biomass induced feast respiration may be followed by the monitoring of on-line dissolved oxygen measurement along with assessment of suspended solids concentrations being delivered to the initial wastewater-biomass mixing zones (Example 8).

In practical application, RBCOD concentration, specific feeding rate, and/or biomass respiration may be used in order to design and control the process with respect to the optimal volumetric blending ratio for recycled biomass and wastewater influent for feast stimulation. The practical approach for achieving a feast respiration response requires attention to the degree of dilution and the method applied for combining influent wastewater RBCOD with biomass directed from famine. The practical constraints on the suitable range of dilution ratio will be influenced by the nominal RBCOD concentration for the wastewater and the extent to which the biomass stream is concentrated before being directed to and mixed with the influent wastewater stream.

In general, feast conditions may be established in environments that are aerobic, anoxic or anaerobic. If aerobic feast is to be applied then it is preferable that dissolved oxygen levels not limit the potential for the aerobic feast metabolic activity that the biomass has capacity to exhibit. Due to the biodegradable nature of RBCOD, it is preferred to stimulate the biomass feast metabolic response in close association to the peak stimulating RBCOD concentration achieved upon mixing influent wastewater with recycle biomass flows. If the feast conditions are to be established by the controlled mixing of influent wastewater and biomass, then dissolved oxygen levels need to be present in sufficient quantities directly at the point of mixing. Since dissolved oxygen levels in influent wastewater and the recycled activated sludge are often times depleted, re-aeration of one or both of these streams prior to mixing will permit for as direct as possible metabolic response in the biomass mixed with the confluent streams (Example 8).

A low sludge residence time (SRT) in combination with well-defined “feast” respiration introduces benefits to the overall practical and economic process viability for reasons related to both the objectives of PHA production and the biological treatment of municipal wastewater RBCOD:
Decreased SRT increases biomass yield on RBCOD. Increased biomass yield ultimately allows for more PHA to be produced because more biomass-with-PAP from the municipal wastewater treatment facility will supply more mass of PHA given an available supply of RBCOD required for ensuing PHA production. Greater biomass yield will also mean that more nutrients such as nitrogen and phosphorus are removed from the wastewater during RBCOD treatment.
Biomass production with decreased SRT will produce a biomass with reduced levels of inert organic suspended solids. Reduced levels of inert solids in the biomass enriches the subsequent accumulation process with more active PHA producing biomass per kilo of biomass harvested from the wastewater treatment process.

One technique to influence the overall process mass balance is by means of advanced particle separation during primary treatment. A significant fraction of the influent wastewater organic matter is present as particulate and colloidal matter. Effective strategies to remove such particulate matter at the front end of the wastewater treatment process will alleviate the contribution of this particulate matter to the biomass. This alleviation may contribute to create a more stringent famine environment after feast. Growth of the biomass exclusively on RBCOD can facilitate a higher level of enrichment due to reduced extraneous organic solids in the biomass and with respect to increasing the selective environmental pressure to promote PHA producing microorganisms. Removed and hydrolysable particulate solids may be used as a source of organic matter for enrichment if fermented into VFA in a side stream and dosed in a controlled way into the feast reactor. Such a VFA complement to the influent substrate may facilitate increased levels of enhancement of PAP. Notwithstanding, it is most preferable to produce biomass based on the influent wastewater RBCOD without concern for its VFA content and then use any VFA derived from fermentation of primary solids (or any other sources for VFA) solely for purposes of the PHA accumulation in the harvested (“wasted”) biomass.

Therefore principles of the present invention may be applied for treating municipal wastewater RBCOD for producing a biomass that may then be used for subsequent PHA production and involve:
Treating a wastewater containing the low concentrations of soluble RBCOD, and
Growing a biomass by the selective consumption of this soluble RBCOD in a highly loaded feast environment.
   And further involve,
Designing loading conditions that will promote significant turnover of PHA in the biomass even if the absolute levels of PHA in the biomass at any point in the wastewater treatment process may be relatively low (less than 10% of TSS) compared to the PAP for the biomass harvested,
Subjecting the biomass to a famine environment after feast as a function of time or the biomass location within the process, and
Separating, and fermenting the colloidal organic compounds for augmenting the feast reactor with VFAs or, in a preferred embodiment, for supplying the accumulation process with these VFAs.

Consequently, by applying the proposed process or method, PHA accumulation potential in the biomass used to treat the wastewater will extend the scope of what one anticipates in present common practice for biomass produced while removing organic contamination from municipal wastewater. Maximum PHA storage potential in the biomass, expressed in a separate post-accumulation process, should be at least in excess of 35% and preferably in excess of 50% g-PHA/g-VSS.

### Example 1

### Full-Scale Municipal Wastewater Treatment Enhancing for PAP with RBCOD

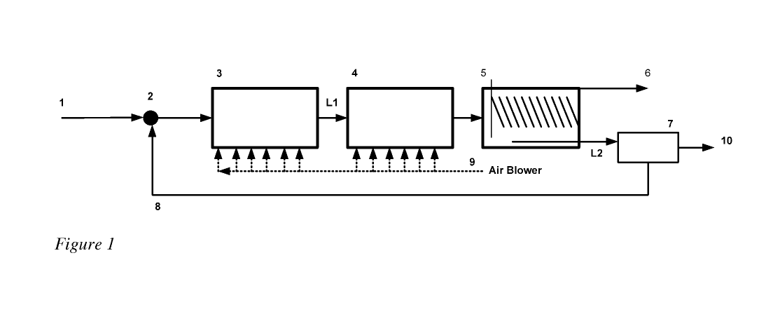

A full-scale municipal wastewater treatment plant was examined toward establishing process design and control criteria for enhancement of PAP with RBCOD. The treatment facility received wastewater corresponding to a population equivalent of 200,000. The focus was on a part of the overall treatment works that received influent wastewater after removal of large particles, grit, oil and grease and comprised the following unit processes (FIG. 1): high rate activated sludge treatment (HRAST), settling and effluent separation, and recycling of biomass to the HRAST. After high rate removal of RBCOD, the wastewater is directed to further treatment for ammonia and residual organic matter removal. More particularly, FIG. 1 schematically illustrates a biological wastewater treatment process that is designed to biologically treat an influent wastewater stream containing RBCOD and, at the same time, enhance PHA accumulation potential of biomass produced in the course of biologically treating the wastewater. Referring to FIG. 1, municipal wastewater containing RBCOD is directed to a mixing point 2 where return activated sludge flowing through line 8 is mixed with the influent wastewater. Combining the influent wastewater with return activated sludge forms mixed liquor. The mixed liquor enters the high rate activated sludge treatment system which, in this case, is comprised of two plug flow tanks or reactors 3 and 4. In this example, a portion of tank or reactor 3 functions as a feast zone. That is, an upstream portion of the tank or reactor 3 will receive mixed liquor that includes a relatively high RBCOD concentration. This will enable the biomass in the mixed liquor to be exposed to feast conditions. In this example, both tanks or reactors 3 and 4 are aerated and, thus, the biomass functions to remove RBCOD from the mixed liquor. As the mixed liquor proceeds downstream through tanks 3 and 4, it is appreciated that the RBCOD concentration of the mixed liquor will decrease. The system and process, in this example, is designed such that when the mixed liquor reaches a downstream portion of the tank or reactor 4, the RBCOD concentration of the mixed liquor will be relatively low compared to the RBCOD concentration of the mixed liquor at the beginning of tank or reactor 3. Thus, famine conditions exist in the downstream end portion of tank or reactor 4. It is appreciated that because of the return activated sludge line 8, biomass is continuously cycled through the feast and famine zones and, accordingly, the biomass is continuously subjected to feast and famine conditions. Mixed liquor exiting the tank or reactor 4 is directed to a solids separator 5. Here a clarified or separated effluent is directed out line 6 and a concentrated sludge or mixed liquor is directed into a collection chamber 7. A portion of the produced biomass is removed as waste activated sludge via line 10. The remainder of the activated sludge biomass is directed through return activated sludge line 8 back to the mixing point 2 where the return activated sludge biomass is mixed with incoming fresh wastewater influent.

The HRAST was with a working volume of 1950 m³ made up with two 18×6 m rectangular tanks in series providing for a plug flow reactor mixing. Influent wastewater daily average flow rate ranged from 1300 to 1800 m³/h. Biomass recycle flow rate after effluent separation was nominally 1400 m³/h. Typical concentrations of the influent wastewater were: 700-1200 mg/L total COD, 200-350 mg/L soluble COD, 10-35 mg/L VFA, 0-10 mg/L ethanol, <2 mg/L methanol, 70-150 mg/L total nitrogen, and 6-20 mg/L total phosphorus. The HRAST dissolved oxygen (DO) concentrations were maintained above 1 mg/L. The hydraulic retention time in the HRAST was estimated to be from 0.5 to 1 h and the volumetric organic loading rate based on soluble COD was from 3 to 8 kg COD/m³/day.

In a biological wastewater treatment process such as that illustrated in FIG. 1, steps and processes can be implemented that will enhance the PHA accumulation potential of the biomass produced during the course of the wastewater treatment. As noted above, it is desirable to subject the biomass to alternating feast and famine conditions. This is described above. One approach to enhancing the PHA accumulation potential of the biomass is to stimulate the biomass to feast on RBCOD by subjecting the biomass to feast conditions that cause the biomass to reach a peak respiration rate that is at least 40% of the extant maximum respiration rate for the biomass. A number of measures or processes can be implemented that will give rise to this peak respiration rate. One example includes stimulating the biomass into a period of feast by exposing the biomass to feast conditions for a selected period of time by applying an average peak feast stimulating RBCOD feeding rate of greater than 5 mg-COD\L\MIN in combination with an average peak specific feast RBCOD feeding rate greater than 0.5 mg-COD\G-VSS\MIN. There are other processes or controls that can be implemented into the wastewater treatment system of FIG. 1 to enhance PHA accumulation potential of the biomass. Another subprocess that contributes to PHA accumulation potential is by implementing a process that maintains the average peak concentration of RBCOD available to the biomass during feast conditions to 10 mg-COD\L-2000 mg-COD\L. At the same time, another subprocess that contributes to the enhancement of PHA accumulation potential is providing a volumetric organic loading rate that is equal to or greater than 2 kg-RBCOD\M³\day. Also by controlling the recycle rate of return activated sludge including the biomass also contributes to enhancing the PHA accumulation potential of the biomass. Based on the research and tests conducted, it is believed that empirically deterimined optimal volumetric influent wastewater to return activated sludge mixing ratios in the range of approximately 0.2 to approximately 5 will contribute to the enhancement of PHA accumulation potential of the biomass. In addition, controlling the dissolved oxygen concentration in the feast zone, or the area of a reactor where feast conditions are initiated and present, also contributes to enhancing the PHA accumulation potential of the biomass. Here the method or process involves generally maintaining the dissolved oxygen concentration in the feast zone at greater than 0.5 mg\0₂\L. Other steps or subprocesses discussed herein can also be implemented in a biological wastewater treatment system such as shown in FIG. 1 to enhance the PHA accumulation potential of the biomass. As discussed above, one of the interesting discoveries is that biomass produced while biologically treating municipal wastewater can be conditioned or treated such that the PHA accumulation potential of the biomass is improved or enhanced. In the same regard, it was surprising to note and see that PHA accumulation potential for biomass could be enhanced even with a wastewater stream where more than 75% of the RBCOD was comprised of compounds other than volatile fatty acids and alcohol.

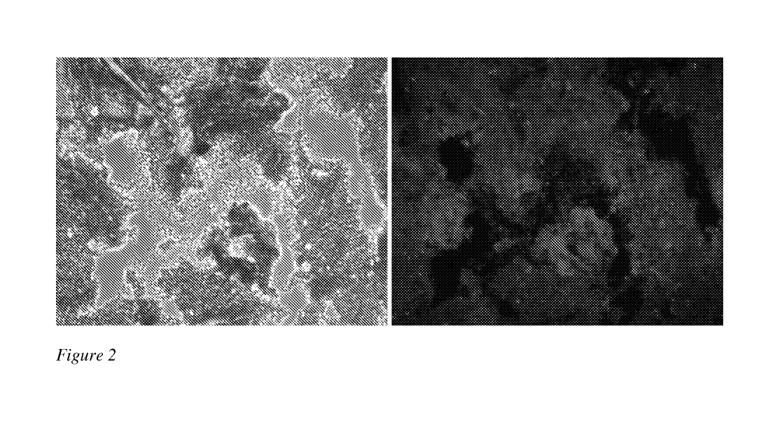

HRAST biomass was enhanced with PHA-accumulating microorganisms. Nile blue A staining of biomass samples, known to selectively stain PHA granules, was examined by epi-fluorescence microscopy (FIG. 2). The staining, resulting in bright red fluorescent sights, indicated that a large fraction of the bacteria in the biomass had capacity to store PHA.

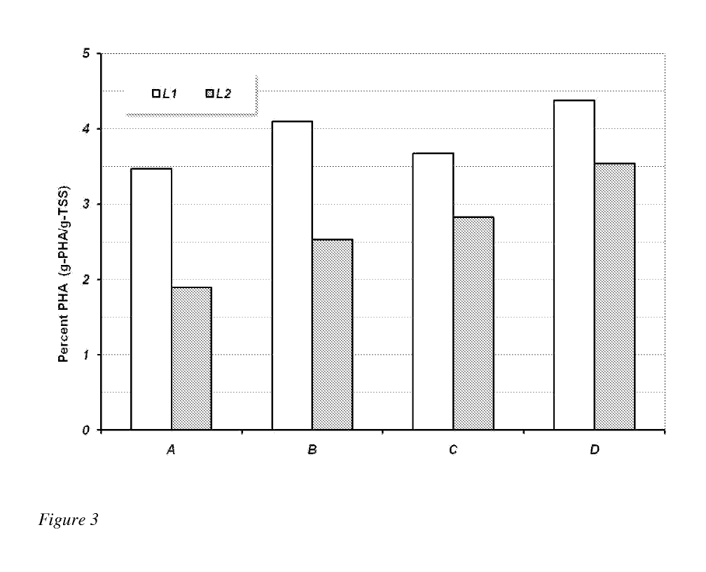

Measurement of PHA in the biomass from the HRAST bioreactor and the clarifier grab samples (positions L₁ and L₂ in FIG. 1) revealed that a substantial turnover of PHA was occurring. In four samples (A-D) taken over the course of two days, the PHA content was consistently higher in the HRAST than after effluent separation (FIG. 3). Mixed liquor grab samples taken from L₁ represented the biomass condition after 50% of the HRAST hydraulic retention time starting from the location of confluence of influent wastewater and recycled biomass streams.

The estimated production of PHA in the HRAST, up to L₁, corresponded on average to 73 kg-carbon per hour (kg-C/h). A similar amount of carbon was consumed between L₁ and the concentrated biomass stream exiting at L₂. The consumption of VFA and alcohols, however, only accounted for a fraction of the carbon converted to PHA (namely 26 kg C/h on average), suggesting that PHA synthesis was occurring from RBCOD sources other than RBCOD as VFA and alcohols.

PHA accumulating potential of the HRAST biomass was estimated to be as high as 51% g-PHA/g-VSS (Example 2 and Example 3). These observations suggested that RBCOD in municipal wastewater of low to negligible VFA and alcohol content could be exploited for producing biomass with enhanced PHA accumulating potential. Continued investigation, but with laboratory scale bioreactors treating municipal wastewater (Example 5) revealed that specific considerations for the biomass feast stimulation environment could be applied towards the kinetics of PHA accumulation in the biomass.

This full-scale biological wastewater treatment plant did not include primary sedimentation. Consequently the biomass content was considered to be influenced by influent particulate organic matter that in general may become adsorbed and retained with the biomass. Furthermore sand and grit removal was not effective. It was observed that the biomass contained a higher than typical fraction of inorganic content. The wastewater treatment plant is not being used today for PHA production but was assessed in this study in order to establish proof of potential for the principles of the present invention in a realistic full scale setting.

### Example 2

### PHA Accumulation by Feed-on-Demand Control in Biomass that has been Enhanced for PAP with Municipal Wastewater RBCOD—Method I

PHA was accumulated in fed batch with harvested activated sludge (WAS) from the full-scale HRAST process described in Example 1. The PHA accumulation was performed in a 155 L stainless steel reactor, and a VFA-rich fermented dairy processing effluent was used for accumulation RBCOD (33.6 g/L soluble COD, 30.9 g-COD/L VFA and less than 100 mg/L soluble total nitrogen). Air was sparged into the reactor and aeration provided for mixing as well as dissolved oxygen (DO) required in the fed batch process. Aliquots (330 mL) of VFA rich fermenter effluent were dosed to the reactor in controlled pulses with dosing intervals regulated based on changes in the biomass respiration rate. Feed-on-demand control was established with injections of the VFA-rich RBCOD when biomass respiration rates decreased relative to the biomass endogenous respiration rate which was measured before the accumulation process was started. DO concentrations were kept above 2 mg/L. The temperature in the reactor was controlled to 15° C. and the accumulation process was terminated after 24 hours.

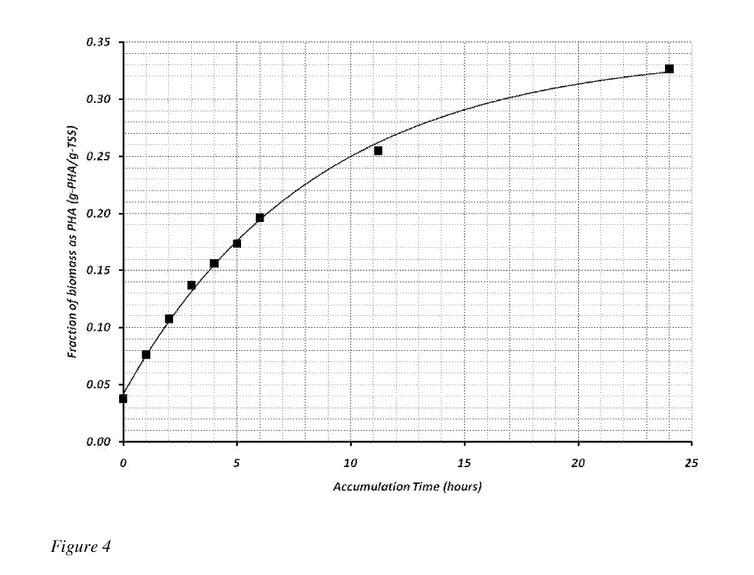

When fed in this manner the HRAST biomass exhibited an estimated PHA accumulation potential (PAP) of 36 (32) % g-PHA/g-VSS (g-TSS) after 24 hours (FIG. 4). The PHA was a copolymer with 95 wt-% polyhydroxybutyrate, and 5 wt-% polyhydroxyvalerate. The trend in FIG. 4 suggested that the biomass had not reached a maximum capacity for PHA accumulation by 24 hours. The estimated capacity of the biomass from the trend was 38% g-PHA/g-VSS.

### Example 3

### PHA Accumulation by Feed-on-Demand Control in Biomass that has been Enhanced for PAP with Municipal Wastewater RBCOD—Method II

PHA was accumulated in fed batch with harvested activated sludge (WAS) from the full-scale HRAST process described in Example 1. A lab-scale reactor (Biostat® B plus, Startorius Stedim Biotech) was used. The accumulation was performed for 24 hours at 25° C. with a VFA mixture of 70% (v/v) of acetic acid and 30% (v/v) of propionic acid. Feed-on-demand control was established based on the increase in pH due to VFA consumption. The pH set point for dose control was defined by the initial pH at the beginning of the accumulation process prior to the first VFA-rich feed input.

When fed in this manner, in replicate accumulation experiments, the HRAST biomass exhibited an estimated 24 hour PHA accumulation potential of 51 (46) % and 43 (39) % g-PHA/g-VSS (g-TSS). The PHAs were copolymers with nominally 67 wt-% polyhydroxybutyrate and 33 wt-% polyhydroxyvalerate.

### Example 4

### PHA-Accumulation-Potential (PAP) in Biomass Using a Reference Assessment Method

The PHA accumulation potential (PAP) was evaluated following a basic reference assessment method that was applied in order to compare biomass samples coming from different sources or over time from the same bioreactor. Biomass grab samples were obtained from conditions representative of famine and were diluted with tap water to 0.5 g-VSS/L. Well-mixed and aerated fed batch reactors were employed. Depending on location, available equipment, and/or other parallel objectives of polymer characterization, the fed-batch reactors were with working volumes of at least 1 L and at most 500 L. Dissolved oxygen was maintained above 1 mg/L. Temperature and initial pH were maintained similar to the biomass source environment. In these reference accumulation potential experiments, two concentrated aliquots of RBCOD were added to the reactor. A concentrated stock solution of sodium acetate was used as RBCOD. The first RBCOD input defined the start of the experiment. The second RBCOD addition was made after 6 hours or after dissolved oxygen increased due to substrate consumption, whichever came first. Each RBCOD input provided a step increase of 1 g-COD/L. Accumulation trends were monitored until the second pulse was consumed (dissolved oxygen increase) or for 24 h, whichever came first. In effect, these standard accumulations were performed with a reference RBCOD source whereby the accumulation was maintained without substrate depletion for at most 24 hours.

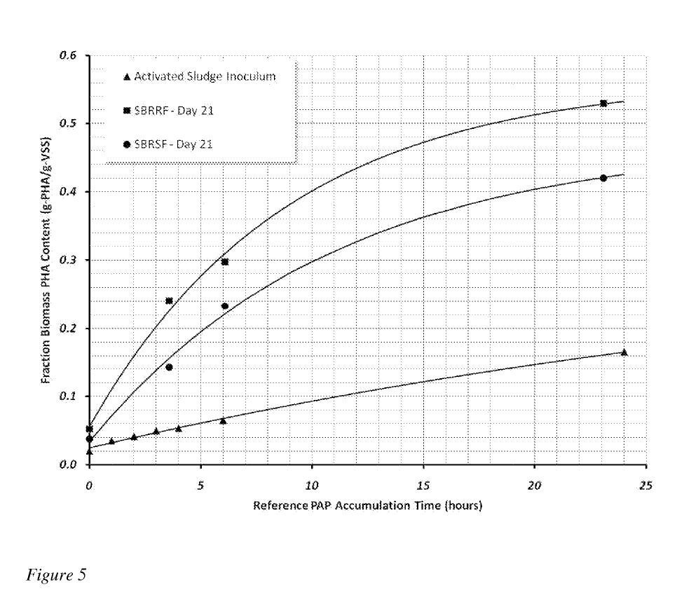

Typical results are shown in FIG. 5 where the trend of PHA accumulation was fit by regression analysis to an empirical function of form:

PAPₜ=A₀+Aₑ(1−exp(−kt))

where,
PAPₜ=the PHA accumulation Potential referenced to t-hours of accumulation
A₀=an empirical constant estimating initial PHA content or PAPₒ
Aₑ=an empirical constant of the extrapolated PHA accumulation capacity
k=a rate constant (h⁻¹) estimating the kinetics of the PHA accumulation PHA content of the biomass was performed following established methods by GCMS (Werker A, Lind P, Bengtsson S, Nordstrom F, 2008. Chlorinated-solvent-free gas chromatographic analysis of biomass containing polyhdroxyalkanoates. Water Research 42:2517-2526) and/or calibrated FTIR (Arcos-Hernandez M, Gurieff N, Pratt S, Magnusson P, Werker A, Vargas A, Lant P. 2010. Rapid quantification of intracellular PHA using infrared spectroscopy: An application in mixed cultures. Journal of Biotechnology 150:372-379).

From the best fit line, the estimated 6 (PAP₆) and 24 (PAP₂₄) hour accumulation potentials were compared as a fraction or percent g-PHA/g-VSS. The rate constant was also considered in order to establish how strategies, of mixing biomass disposed to feast with influent wastewater, influenced the rate of accumulation.

To illustrate (see Example 5, Experiment E2), reference PAP assessment was performed to measure for the enhancement of PAP for an activated sludge coming from a full scale municipal wastewater treatment plant. A grab sample of biomass was obtained from a large European treatment works that services a population equivalent of 1.4 million people. The activated sludge grab sample became the inoculum to seed two laboratory scale bioreactors similarly treating a municipal wastewater, following the methods of the present invention. The respective extant 6 and 24 hour PAP for the activated sludge inoculum from the full-scale treatment plant were observed to be 7 and 17% g-PHA/g-VSS. One SBR (SBRRF) was operated for feast with an influent wastewater to mixed liquor mixing ratio of 3. In the other SBR (SBRSF) an estimated average maximum specific feast RBCOD feeding rate, of 0.5 mg-COD/g-VSS/min, was applied. After 21 days of applying the methods of the present invention, PAP for both SBRs became significantly enhanced with a PAP₆ (PAP₂₄) of 31 (53) percent g-PHA/g-VSS for SBRRF and 22 (43) percent g-PHA/g-VSS for SBRSF (FIG. 5).

### Example 5

### Treatment of Municipal Wastewater in Two Parallel Laboratory-Scale Sequencing Batch Reactors Operated with Different Feeding Regimes and Starting with Different Sources of Activated Sludge

Two laboratory-scale (4 L) sequencing batch reactors (SBRs) were operated in parallel to biologically treat a municipal wastewater. The influent wastewater was screened to remove suspended solids before being disposed to the laboratory scale SBRs. The wastewater was obtained directly from the sewer system serving 150 European communities summing to a combined wastewater flow rate of 1.7 million m³/day. PAP exhibited by the activated sludge harvested from the two laboratory SBRs was investigated over time starting with two different activated sludge sources as inoculum. In a first round of experiments (E1), activated sludge from the HRAST described in Example 1 was used as the starting culture. In the second round of experiments (E2), activated sludge grab sampled from a conventional municipal activated sludge wastewater treatment plant described in Example 4 was used. E1 aimed to start with a biomass already exhibiting enhanced PAP and assess the scope for maintenance of PAP with the methods of the present invention over time and in a more controlled laboratory setting. E2 was directed towards starting with a biomass with low PAP and assessing the potential to enhance for PAP by applying the methods of the present invention.

Both reactors were operated the same with nominal solids residence time (SRT) of 1 day and hydraulic retention time (HRT) of 0.9 hours. An organic loading rate based on the soluble COD 6 g-COD/L/day was applied to each. The two SBRs were operated with repeated cycles including stages of:

| | | |
|---|---|---|
| 1. Feed Influent and reaction | 40 | minutes |
| 2. Discharge waste activated sludge (WAS) | 30 | seconds |
| 3. Settle the activated sludge | 80 | minutes |
| 4. Decant the treated wastewater | 3 | minutes |

For E1, influent feed and reaction was maintained aerobic. The only distinguishing feature in SBR operations was the mode of influent supply. SBR rapid feed (SBRRF) was rapidly fed influent wastewater at a flow rate of 1 L/min. SBR slow feed (SBRSF) was fed at much lower constant flow rate of 0.075 L/min. The mixed liquor volume before influent pumping was 1 L. Three liters of wastewater were added per cycle. WAS discharge volume was equal to 57 mL per cycle. Dissolved oxygen (DO) concentrations were maintained between 1 and 3 mg/L by automatic on/off regulation and the trend of DO consumption, with aeration turned off, was used to estimate oxygen uptake rates (OUR). The temperature of the reactors was controlled to 20° C. and pH was monitored but not controlled.

Average concentrations of the screened influent wastewater were as follows: 420 mg-TSS/L, 350 mg-VSS/L, 640 mg-COD/L total COD, 224 mg-COD/L soluble COD, 97 mg-N/L total nitrogen, and 12 mg-P/L total phosphorus. Volatile fatty acid concentrations in the wastewater influent were variable ranging from non detectable to 58 mg/L total VFAs in grab samples. Alcohols (ethanol and methanol) were observed to be not detected and were assumed to be less than 5 mg/L, respectively based on the anticipated instrument detection limits.

The influent wastewater RBCOD concentration was determined according to the aerobic batch test method described by Ekama, G. A., Dold, P. L., Marais, G. V. (1986) Procedures for determining influent COD fractions and the maximum specific growth-rate of heterotrophs in activated-sludge systems. Water Science and Technology, 18 (6), 91-114. Wastewater was filtered (GF/C, pore size 1.2 μm) and a selected volume was added to an aerated and stirred batch reactor (3 L) together with a selected volume of mixed liquor from one of the above mentioned 4 L SBRs. The mixed liquor was recirculated (0.45 L/min) to a respirometer (0.3 L) equipped with a dissolved oxygen probe. At defined intervals, the recirculation was interrupted and oxygen uptake rate (OUR) was estimated from the dissolved oxygen depletion curve. RBCOD was assessed by this manner on several occasions during E1. It was found that although the estimated RBCOD was variable (43-144 mg-COD/L), the fraction of RBCOD over soluble COD (SCOD) was consistent and on average 0.48±0.04 g-COD/g-COD. Therefore the SBRs were operated with a volumetric organic loading rate based on RBCOD of approximately 3 g-COD/L/day

Based on these RBCOD evaluations the estimated average peak supply rates of RBCOD to biomass in SBRRF and SBRSF were 112 and 8 mg-COD/L/min, respectively.

For E1, the SBRs were operated over 77 days with SBRRF and SBRSF stabilizing with average respective VSS concentrations of 4.5 and 4.15 mg-VSS/L in 4 liters. As a result, the specific average peak feeding rate of RBCOD to the reactor biomass at the start of each cycle in 1 liter was 6.2 and 0.5 mg-COD/g-VSS/min for SBRRF and SBRSF.

The wastewater biological treatment performance was similar for both SBRs with average contaminant reduction of total COD by 70%, soluble COD by 65%, total nitrogen by 30% and total phosphorus by 40%.

For E1, PAP for WAS from SBRRF and SBRSF was evaluated on five occasions (day 22, 36, 43, 66 and 77) and on the same days for both SBRs. The reference PAP assessment method (Example 4) was performed in parallel 4 L reactors. Typical results of trends have been shown in FIG. 5 (Example 4) where the trend of accumulation was fit by regression analysis as previously described.

From the best fit line, the estimated 6 (PAP₆) and 24 (PAP₂₄) hour accumulation potentials were compared (percent g-PHA/g-VSS). In addition, the estimated rate constant (k in Example 4) provided for an indication for any systematic shifts in the kinetics of PHA accumulation. Both SBRRF and SBRSF yielded comparable results. PAP_{E} and PAP₂₄ were estimated at 22±5 and 38±5% g-PHA/g-VSS for SBRRF, and were 20±7 and 42±9% g-PHA/g-VSS for SBRSF, respectively. The rate constant for accumulation was observed to be variable. However, the accumulation rate constant was nevertheless more variable and on average lower for SBRSF (0.08±0.06 h⁻¹), wherein the rate constant decreased in a statistically significantly manner over time and after 36 days of operation. The average estimated PAP rate constant for SRBRF was 0.12±0.04

These results suggested that both SBRRF and SBRSF maintained accumulation potentials. However, SBRSF suffered over time in maintaining similar accumulation kinetics compared to SBRRF. Nevertheless, the results from E1 confirmed the ability to sustain PAP in activated sludge treating a municipal wastewater based on RBCOD independent of VFA and alcohol content. A greater stimulation of the biomass tended to maintain improved accumulation kinetics so long as influent wastewater loading to the biomass is applied at levels that are not otherwise inhibiting. Inhibition can be evaluated with established methods (Example 7). Feast conditions can be also assessed in terms of achieving a maximum specific loading to the biomass. The average estimated peak specific RBCOD loading of 0.5 mg-COD/g-VSS/min was sufficient to maintain accumulation potential in the biomass. However, the results indicated that higher specific RBCOD loading rates will tend to provide for higher PHA accumulation kinetics.

In order to answer the question of whether this peak specific feeding rate was sufficient to enhance for PAP in activated sludge biomass, the parallel SBRs were emptied, cleaned and restarted (E2), but now restarted with the activated sludge inoculum of known low PAP₆ (and PAP₂₄) of 7 (and 17) percent g-PHA/g-VSS (Example 4). In slight modification to the operating conditions from E1, SBRRF was “dump fed” by bringing the 3 L of influent wastewater into SBRRF at 1 L/min but without mixing and aeration. Aeration and mixing were commenced once the influent was fully introduced. Thus, SBRRF in E2 was operated with an influent mixing ratio of 3 (Example 7).

After 21 days of operation PAP₆ (and PAP₂₄) were observed to be 31 (53) and 22 (43) percent g-PHA/g-VSS (TSS), for SBRRF and SBRSF (FIG. 5, Example 4). A second reference PAP assessment was made after 35 days of operation. The results were reproduced. SBRRF PAP₆ (PAP₂₄) was 16 (41) percent g-PHA/g-VSS. SBRSF PAP₆ (PAP₂₄) was 15 (39) percent g-PHA/g-VSS.

In summary, these findings support the invention by demonstrating enhanced PAP in the treatment of real municipal wastewater RBCOD.

### Example 6

### Measurement of Induced Biomass Respiration for Activated Sludge from Different Sources and with Stimulation Using a Reference RBCOD Source

Biomass respiration as a function of reference RBCOD (acetate) concentration was assessed. Samples of activated sludge (AS) mixed liquor were obtained from pilot scale (PSAS), laboratory scale (LSAS) and full scale (FSAS) wastewater treatment processes. The LSAS was the biomass harvested in Example 5 Experiment E2. Similarly, the FSAS was the biomass from the full scale treatment plant that was used to inoculate the laboratory reactors in

### Example 5

### Experiment E2

PSAS came from a pilot plant scale facility being operated in Sweden for the technology research and development and producing biomass with enhanced PAP from treating high strength dairy industry wastewater. The pilot plant consisted of a sequencing batch reactor (SBR). The SBR was with a working volume of 400 L operated with 12 hour cycles. Biomass retention in the SBR was by gravity settling. The nominal wastewater hydraulic retention time (HRT) was 1 day and the process has been driven with various sludge ages (solids retention time or SRT) between 1 and 8 days. Organic loading rates from 1 to 2 g-RBCOD/L/d were applied and nutrients were supplied as necessary so as not to be limiting for microbial growth in the wastewater treatment process. This activated sludge biomass has routinely exhibited a significant PHA accumulation potential exceeding 55 percent g-PHA/g-VSS in 6 hours following the method described in Example 2.

Therefore, PSAS, LSAS, and FSAS were selected from systems yielding a range of anticipated PAP of approximately 55, 40 and 17 percent g-PHA/g-VSS, respectively.

Mixed liquor grab samples were taken from zones or periods in the bioreactors which most closely resembled famine environmental conditions. Biomass pellets were harvested, in at least triplicate and from a volume of mixed liquor of at least 30 mL, by centrifugation (4000×g for 10 minutes). The pellets were dried at 105° C. and weighed for estimating mixed liquor total suspended solids. The VSS was thereafter estimated following standard methods. Respective mixed liquor subsamples were diluted similarly (5 times) with tap water in order to bringing the biomass concentrations in the order of 1 g-VSS/L. Aliqouts (120 mL) of the diluted AS were placed in 250 mL Schott flasks which were subsequently sealed and the closed bottles were vigorously shaken for 1 minute for pre-aeration and to establish near saturation initial dissolved oxygen (DO) concentrations. A mass of acetate was added to the freshly aerated mixed liquor by adding a small volume from a concentrated stock solution (10 mg-COD/mL) and the contents were rapidly mixed and transferred to a 120 mL standard BOD bottle. A DO electrode was immersed into the bottle displacing some liquid and sealing the vessel contents from external sources of dissolved oxygen exchange. The vessel contents were maintained well-mixed by a magnetic stirrer. Depletion of dissolved oxygen in the well-mixed BOD bottle was logged (Hach HQ40d with LDO101 Probe) over time and the oxygen uptake rate (OUR) was estimated from the linear slope of the ensuing depletion curve. SOUR was estimated by normalizing the OUR by the derived diluted activated sludge concentration. The endogenous respiration rates were applied as a reference for calculating an induced respiration rate (SOURᵢ) as:

SOURᵢ(S)=SOUR_{O}(S)−SOURₒ(S=0)

where

SOURᵢ=induced respiration referenced to endogenous respiration

SOURₒ=observed SOUR as a function of substrate concentration=

A=RBCOD-acetate (substrate) concentration

In agreement with previous experiments that we have performed, the stimulation of biomass respiration rate was observed to fit well to the empirical model:

$${SOUR}_{i} = \{ \begin{matrix}m ln ( \frac{S}{{S}_{f}} ) , S \geq {S}_{f} and m ln ( \frac{S}{{S}_{f}} ) \leq {SOUR}_{ma x} \\ {SOUR}_{ma x} , S \geq {S}_{m} and m ln ( \frac{S}{{S}_{f}} ) > {SOUR}_{ma x}\end{matrix}$$

where,

SOURᵢ=the induced specific oxygen uptake rate

m=the biomass response factor to the organic substrate stimulus

S=initial RBCOD concentration providing the stimulus (mg-COD/L)

S_{f}=the RBCOD concentration for measureable biomass response

Sₘ=the RBCOD concentration achieving maximum respiration

SOURₘₐₓ=the maximum extant specific oxygen uptake rate

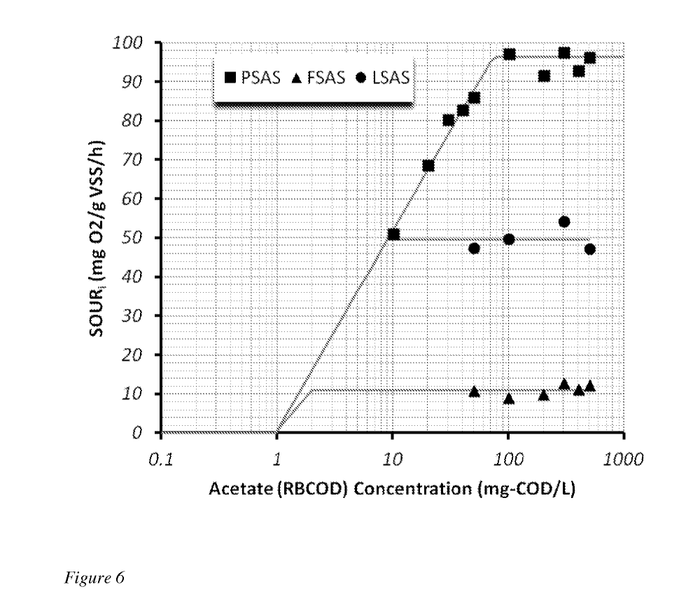

From three sources of mixed liquor representing a wide range of PAP, we observed that in all cases a maximum respiration was achieved by an RBCOD-acetate concentration of 100 mg-COD/L (FIG. 6). Furthermore, SOURₘₐₓ increased with degree of PAP from these selected biomass sources. These data suggested that for a biomass with known significant PAP (PSAS), SOUR, became significant by an RBCOD-acetate concentration of 10 mg-COD/L. It was anticipated that acetate provided for a reference representing the biomass response but other forms of RBCOD may stimulate the biomass respiration to different extent depending on history of acclimation.

### Example 7

### Measurement of Induced Biomass Respiration for Activated Sludge from Different Sources and with Stimulation using Primary Effluent Municipal Wastewater

Mixed liquor biomass respiration as a function of influent wastewater blending was assessed. Samples of activated sludge (AS) mixed liquor were obtained from laboratory scale (LSAS) and full scale (FSAS) municipal wastewater treatment processes (see Example 6). Two different municipal wastewaters were assessed and the respective AS mixed liquor grab samples were well-acclimated to the wastewaters that were applied. LSAS was produced on a municipal wastewater (Example 5). FSAS was produced in a large scale European city treatment works (Example 4). The wastewater samples used for this study had undergone primary treatment including sand, grit and grease removal.

Activated sludge was sampled from zones or periods in the bioreactors which most closely resembled famine environmental conditions. The VSS concentration of the activated sludge grab samples were assessed in at least triplicate. Biomass pellets from a volume of mixed liquor (at least 30 mL) were harvested by centrifugation (4000×g for 10 minutes). Pellets were dried at 105° C. and weighed to estimate the total suspended solids concentration. The VSS was thereafter estimated following standard methods. Mixed liquor subsamples were diluted similarly (5 times) with tap water bringing the VSS concentrations in the order of 1 g/L. Aliquots of diluted mixed liquor and wastewater were selected such that in their combination a 120 mL mixture would be produced. These biomass and substrate volumes were placed in separate 250 mL Schott flasks which were sealed and both closed bottles were vigorously shaken in parallel for 1 minute for pre-aeration and to establish near saturation initial dissolved oxygen concentrations in both. The biomass and wastewater volumes were combined, rapidly mixed and transferred to a 120 mL BOD bottle. A DO electrode was immersed into the bottle displacing some liquid and sealing the vessel contents from external sources of dissolved oxygen exchange. The vessel contents were well-mixed by a magnetic stirrer. Depletion of dissolved oxygen in the well-mixed BOD bottle was monitored (Hach HQ40d with LDO101 Probe) over time and the oxygen uptake rate (OUR) was estimated from the linear slope of the ensuing depletion curve. The induced specific respiration for the biomass (SOURᵢ) as a function of mixing ratio (D) was referenced to the measured endogenous respiration rate while also being corrected in proportion to the observed OUR coming from the wastewater itself:

$${SOUR}_{i} ( D ) = \frac{〚 {( OUR 〛}_{O} ( D ) - {OUR}_{O} ( D = 0 ) - {f}_{w} \cdot {OUR}_{w} )}{{f}_{a} \cdot X}$$

$$D = \frac{{V}_{w}}{{V}_{a}} , {f}_{w} = \frac{{V}_{w}}{{V}_{a} + {V}_{w}} , {f}_{a} = \frac{{V}_{a}}{{V}_{a} + {V}_{w}}$$

where,

SOURᵢ=induced specific oxygen uptake rate

OURₒ=observed OUR as a function of mixing ratio

OUR_{w}=observed OUR for the influent wastewater

D=volumetric mixing ratio applied (wastewater to mixed liquor)

V_{w}=influent wastewater volume applied

Vₐ=activated sludge (mixed liquor) volume applied

Xₐ=VSS concentration in the volume Vₐ

fₐ=fraction of activated sludge in the combined volume

f_{w}=fraction of influent wastewater in the combined volume

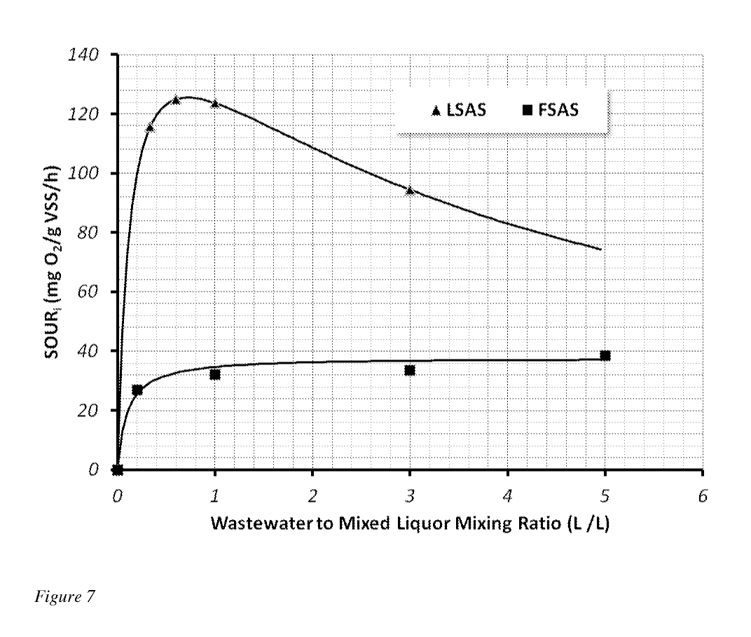

As anticipated the LSAS with known high PAP (Example 4) exhibited higher levels of respiration when combined with the influent wastewater (FIG. 7). However, in both cases significantly high respiration, with respect to the maximum level, was already encountered by a mixing ratio of 0.2. The influent wastewater grab sample applied to the acclimated LSAS indicated for presence of inhibitory substances. Mixing ratios higher than 1 were observed to begin to inhibit the LSAS activity from this particular influent wastewater grab sample.

### Example 8

### An Example with Suspended Biomass Growth and Continuous Feed

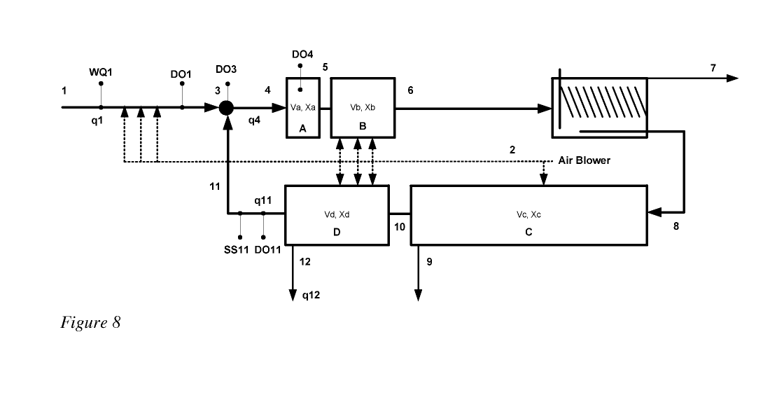

The process configuration (FIG. 8) is intended to stimulate feast by achieving a defined influent wastewater to recycle biomass mixing ratio (Example 7). A reservoir of biomass is maintained in order to provide for flexibility in recycle flow demand. On-line monitoring points are indicated with redundancy and for illustration. Influent wastewater (1) containing RBCOD is disposed to the process at a volumetric flow rate of q₁. Aerobic conditions are controlled and maintained in selected locations by means of air supplied and sparged into the system by one or multiple of blowers (2). Influent wastewater quality is monitored on-line (WQ₁) for suspended and dissolved contaminant content with techniques such as scanning spectroscopy. The influent flow q₁ is aerated and the resultant dissolved oxygen level is monitored on-line (DO₁). Influent pre-aerated wastewater and recycled activated sludge disposed from an environment of famine (11) are combined (3) with a selected mixing ratio by means of adjustment of recycle flow rate q₁₁. Recycle suspended solids (SS₁₁) and dissolved oxygen (DO₁₁) concentrations are monitored on-line. The confluent mixed liquor (4), with volumetric flow (q₄), and feast stimulated biomass concentration (Xₐ) are disposed to a short HRT well-mixed “contact” reactor A with volume Vₐ. Reactor A may be aerated. Dissolved oxygen levels (DO₄) are monitored just prior to, or within, Reactor A for assessment of the biomass respiration rate for the process control. Following Reactor A, the mixed liquor enters Reactor B (5) which is preferably a plug flow design of volume V_{b}, and is applied towards biological removal of at least RBCOD from the wastewater. Treated wastewater is disposed (6) to biomass separation, and treated wastewater effluent is released (7). Concentrated biomass is directed (8) after effluent separation to a further thickening/storage Reactor C, for which sufficient aeration may be supplied in order to just sustain the biomass. Supernatant from eventual biomass thickening under storage is decanted (9) and directed towards the process influent (1). Recycled biomass enters (10) a well-mixed fully aerobic famine environment in Reacter D, and waste activated sludge is harvested (12) at a defined flow rate (q₁₂) for SRT control. Harvested biomass is directed to sludge handling during which PHA is accumulated and recovered as a value added product.

With reference to Example 7, the mixing ratio for inducing feast is given by:

$$D = \frac{{q}_{1}}{{q}_{11}}$$

The estimated recycled biomass concentration in Reactor A is:

$${X}_{a} = \frac{{q}_{11} \cdot {SS}_{11}}{{q}_{1} + {q}_{11}} = \frac{{q}_{11} \cdot {SS}_{11}}{{q}_{4}}$$

The hydraulic residence time (θₐ) in the contact reactor A is:

$${θ}_{a} = \frac{{V}_{a}}{{q}_{4}}$$

Neglecting mixing and pipe volumes (3 and 4), the applied feast feeding rate (Qₛ) and specific feast feeding rate (qₛ) for an influent RBCOD concentration of S₁ may be estimated by:

$${Q}_{s} = \frac{{q}_{1} {S}_{1}}{{V}_{a}}$$

$${q}_{s} = \frac{{q}_{1} {S}_{1}}{{V}_{a} {X}_{a}}$$

Neglecting pipe volumes, a measure of biomass feast stimulation trends is provided by:

$${SOUR}_{a} = \frac{{DO}_{3} - {DO}_{4}}{{θ}_{a}}$$

If the marginally maintained biomass activity in Reactor C may be neglected then the sludge retention time SRT (θₓ) based on the active aerobic process volumes is estimated by:

$${θ}_{x} = \frac{{V}_{a} {X}_{a} + {V}_{b} {X}_{b} + {V}_{d} {X}_{d}}{{q}_{12} {X}_{d}}$$

### Example 9

### An Example with Biofilm Biomass Growth and Continuous Feed

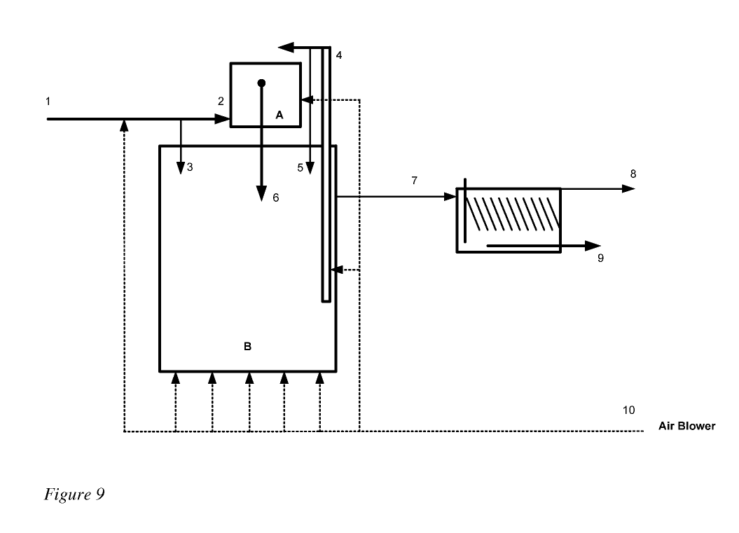

The process configuration (FIG. 9) is intended to stimulate feast by achieving a defined influent wastewater to recycle biomass mixing ratio (Example 7). On-line monitoring can be applied in similar ways to those shown in Example 8 and are not included here. The process includes well-mixed contact (A) and main (B) reactors serving feast stimulation and biological treatment of at least the wastewater RBCOD. The biomass is grown as a biofilm on media that are aerated (10) and well-mixed within reactors A and B. These type of biofilm reactors are commonly referred to as a moving bed bioreactors (MBBRs). Detachment of biofilm biomass, occurring by a natural process of sloughing or by means of purposefully applying additional shear stress to the bioflim, is disposed (7) to a separation unit process from which treated effluent (8) is discharged and wasted biomass is harvested (9). Harvested biomass is directed to sludge handling during which PHA is accumulated and recovered as a value added product. Influent wastewater (1) is pre-aerated and directed to MBBR-A (2). Option exists for by-passing a fraction of the influent flow directly to the main reactor (3). Biofilm media is recycled to MBBR-A using, for example, an airlift (4) system. The MBBR media delivery rate may be controlled by the airlift operating conditions and by diverting media or liquid back to MBBR-B (5). Thus, the by-pass (5) can be employed to delivery more media and less liquid volume from MBBR-B to MBBR-A in this biomass (media) recycle. Therefore the influent wastewater to recycle flow mixing ratio is controlled by a combination of flow rates involving by-pass streams. After feast stimulation in the MBBR-A contact reactor, wastewater is directed (6) to the main MBBR-B reactor for at least RBCOD treatment. Biofilm media are also directed to MBBR-B (6) after feast stimulation, but the hydraulic retention time of media in MBBR-A may be decoupled to the liquid hydraulic retention time by means of selective retention of the biofilm media. Therefore, biomass comprising the media biofilm may be exposed to feast for periods longer than those imposed by the hydraulic flow into MBBR-A.

### Example 10

### An Example with Suspended Biomass Growth and Semi-Continuous Feed

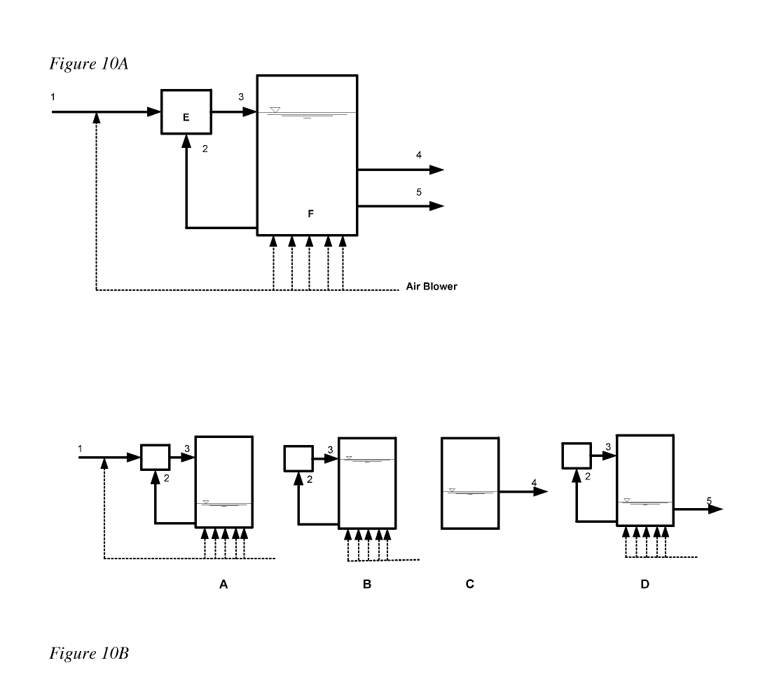

The process configuration (FIG. 10A) is intended to stimulate feast by achieving a defined influent wastewater to recycle biomass mixing ratio (Example 7). On-line monitoring can be applied in similar ways to those shown in Example 8 and are not included here. The sequencing batch reactor is cycled through stages (FIG. 10B) of influent feeding (A), wastewater treatment (B), biomass separation and effluent discharge (C), biomass re-suspension and wasting (D). Influent wastewater (1) is pre-aerated and directed towards a well-mixed feast stimulation contact reactor (E). During the influent feeding, mixed liquor is recycled (2) in order to achieve a set influent feed to recycle biomass mixing ratio. The confluent recycle flow (3) enters the main reactor F. Recycle may be maintained once influent has been introduced and at least the RBCOD in the wastewater is treated (B). Mixing and aeration are stopped to allow for effluent and biomass separation by gravity (C). In another embodiment, biomass separation can also be achieved using dissolved air flotation. Treated effluent (4) is discharged (C) and following re-aeration and mixing (D), waste activated sludge may be harvested (5). Harvested biomass is disposed to sludge handling during which PHA is accumulated and recovered as a value added product.

### Example 11

### Illustrative Overall Process Schematic for Producing Biomass with PHA-Producing-Potential by Municipal Wastewater Treatment with Parallel Objectives of Low Residual Sludge Production

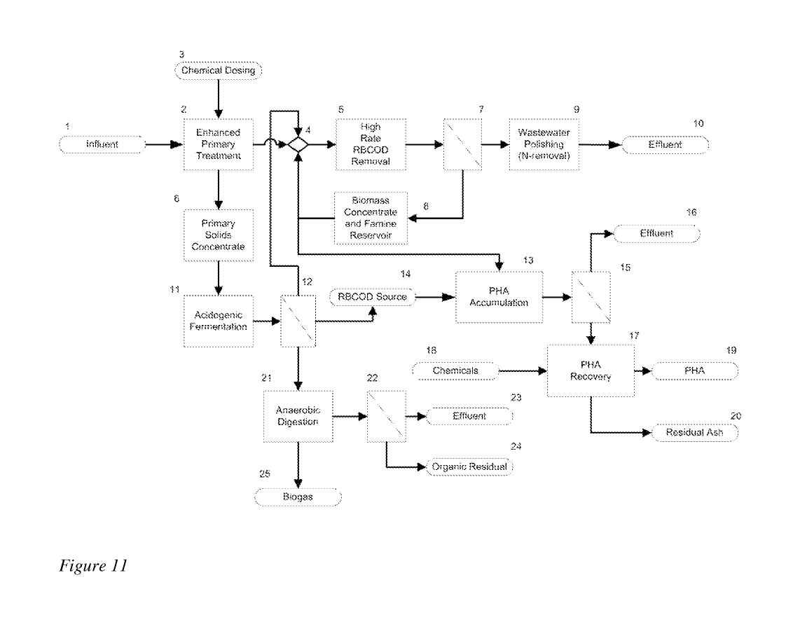

This example provides a conceptual process schematic for producing activated sludge from municipal wastewater treatment for purposes of PHA production and ultimately low residual sludge production (FIG. 11).

Influent municipal wastewater after screening, and grit removal, (1) is directed towards an advanced primary treatment unit process (2). Advanced primary treatment achieves removal of readily and non-readily settleable particulate organic matter. The unit process (2) may require chemical dosing such as ferric chloride and cationic polymer (3). Ferric chloride will also reduce dissolved phosphorus levels in the wastewater. The discharge from enhanced primary treatment will be a primary solids concentrate (6) as well as an effluent with significantly reduced particulate organic matter but with remaining soluble RBCOD. RBCOD effluent from (2) is combined in (4) with return (famine) activated sludge from (8), and optionally a VFA rich side stream from separator (12). The mixing of streams at (4) is designed to stimulate a distinct feast response for the biomass that drives PHA storage metabolism. The biomass feast response is driven towards famine in a highly loaded bioreactor (5).

The “feast” bioreactor (5) serves to remove RBCOD from the wastewater. Thus the effluent wastewater from (5) can be considered to be treated with respect to the influent (1) organic content. Reactor (5) may be aerobic, anoxic or anaerobic in design. While this example is for suspended microbial growth as “activated sludge”, the principles are readily adapted to growth of a PHA-producing biomass using biofilm technologies. In another embodiment of the same process, bioreactor (5) can provide for both feast and famine metabolism as may be achieved, for example, in a suitably designed plug flow reactor configuration.

The biomass and wastewater from (5) are separated (7) and the biomass is disposed to a holding reservoir (8). The holding reservoir can provide further for “famine” conditions and can be maintained as aerobic, micro-aerobic, anoxic, or essentially anaerobic. PHA stored as consequence of feast activity in (4) and (5) should become consumed as a consequence of ongoing microbial metabolism during its residence in (5), (7) and/or (8). Clarified effluent from (7) may need further treatment in unit processes designed for nitrogen removal and more recalcitrant organic carbon removal (9). Moving bed bioreactor technologies are well-suited to these aims. Note that as a practical matter to the process and the technology for biomass production for PHA-accumulation, the wastewater treatment polishing (9) is not essential but may need to be incorporated to the flow scheme in order to satisfy case-to-case specific final effluent water quality criteria. The treated municipal wastewater is discharged (10).

The primary solids concentrate (6) are fermented (11) to yield a liquid stream rich in RBCOD. Although not shown, other organic residue that has been collected from the raw influent, such as but not limited to grease and fat, may also contribute to the fermenter loading. The fermented effluent is separated (12) and the RBCOD rich effluent can be utilized to increase the “feast” response in the return biomass (4). Retained organic solids from (12) are disposed to anaerobic digestion (21) resulting in solids destruction and a reduced organic residual (24) plus an effluent (23). Effluent (23) may need further treatment before final discharge and it may be possible to achieve this objective by disposing effluent (23) to the polishing unit process (9). Biogas (25) is produced from anaerobic digestion (21).

Excess biomass produced by (5) can be wasted from (8) and, in so doing, the activated sludge solids retention time can be controlled. Excess biomass is combined with a source of RBCOD (14) in accumulation process (13) whereby RBCOD is used to realize the PHA-accumulation-potential of the biomass. The biomass from (13) is PHA-rich and is directed after separation (15) to the PHA recovery system (17). Effluent (16) will be treated with respect to the RBCOD content of (14).

The PHA recovery process (17) will require chemical inputs (18) and will entail activities of PHA-rich biomass drying, PHA extraction, and residual non-PHA organic pyrolysis or incineration. The output from (17) is PHA and an inorganic P-rich ash. Thus the biomass from (8) will ultimately be consumed towards contribution of energy reclamation in (17).

### Example 12

### Illustrative Process Schematic for Producing Biomass with PHA-Producing-Potential by Municipal Wastewater Treatment with Parallel Objectives of Low Residual Sludge Production

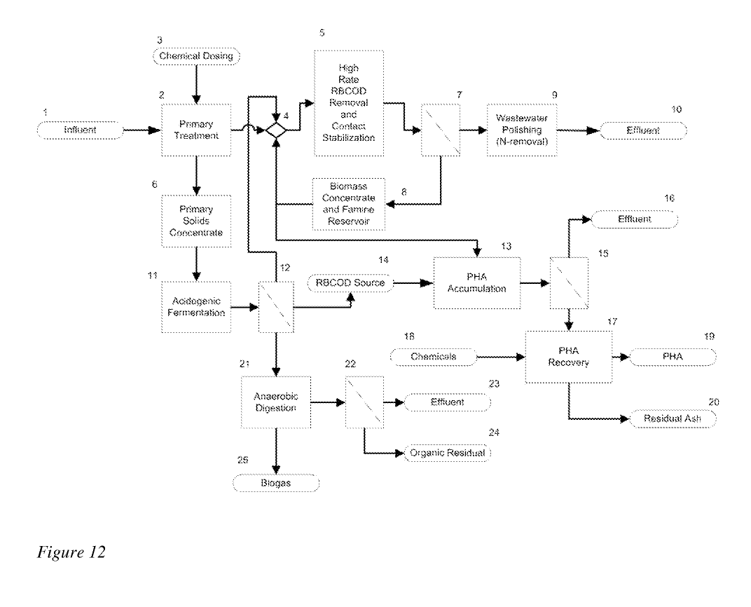

In this example (FIG. 12), the process scheme is the same as the one shown in Example 11. However, in this case primary treatment (2) is not “advanced” meaning that from the influent (1) only readily settleable organic solids are removed before reactor (5). The bioreactor (5) removes soluble RBCOD under conditions of loading that stimulate a feast response in the active biomass. At the same time the biomass is used for removal of the colloidal fraction of the influent COD by physical adsorption (so-called contact stabilization). This biomass with adsorbed particulate matter is directed to reactor (8) where retention time is provided to achieve hydrolysis and biodegradation of the adsorbed particulate matter. The retention time in (8) is also such that eventual famine conditions are achieved in the biomass. Therefore, biomass recycled from (8) back to (5) comes from a famine metabolic activity and is stimulated into a new cycle of feast. Thus reactor (5) achieves feast stimulation of the biomass, biological removal of soluble RBCOD, and physical removal of the non-readily settleable influent particulate COD.

1. A method of treating municipal wastewater comprising:
a. directing the municipal wastewater containing readily biodegradable chemical oxygen demand (RBCOD) to a treatment zone;
b. biologically treating the wastewater in the treatment zone by removing contaminants from the wastewater;
c. while treating the wastewater producing a biomass;
d. enhancing the polyhydroxyalkanoate (PHA) accumulation potential of the biomass by:
i. exposing the biomass to alternating feast and famine conditions; and
ii. after exposing the biomass to famine conditions, stimulating the biomass into a period of feast by exposing the biomass to feast conditions for a selected period of time by applying an average peak feast stimulating RBCOD feeding rate of greater than 5 mg-COD/L/min in combination with an average peak feast specific RBCOD feeding rate greater than 0.5 mg-COD/g-VSS/min.

2. The method of claim 1 wherein stimulating the biomass into a period of feast includes maintaining the peak concentration of RBCOD available to the biomass during feast conditions to 10 mg-COD/L-2000 mg-COD/L.

3. The method of claim 1 wherein the wastewater being treated includes a volumetric organic loading rate based on RBCOD equal to or greater than 2 kg-COD/m³/day.

4. The method of claim 1 including providing a wastewater influent stream wherein more than 50% of the RBCOD comprises on average compounds other than volatile fatty acids and alcohols.

5. The method of claim 1 including providing a wastewater influent stream wherein more than 75% of the RBCOD comprises on average compounds other than volatile fatty acids and alcohols.

6. The method of claim 1 further including stimulating feast conditions by premixing biomass with fresh influent wastewater.

7. The method of claim 6 including mixing the biomass with influent wastewater such that the volumetric mixing ratio of wastewater to recycled biomass is approximately 0.1 to approximately 5.0.

8. The method of claim 1 wherein the biomass and wastewater are mixed and wherein the feast conditions are executed in a feast zone; and wherein the method includes generally maintaining the dissolved oxygen concentration in the feast zone at greater than 0.5 mg-O₂/L.

9. The method of claim 1 including directing an influent municipal wastewater stream into the treatment zone; recycling at least a portion of the biomass and mixing the recycled biomass with the influent wastewater; and basing biomass recycle rate on: (1) the water quality of the influent wastewater determined by online monitoring or (2) induced biomass respiration rate.

10. The method of claim 1 including directing an influent municipal wastewater stream into the treatment zone; recycling at least a portion of the biomass and mixing the recycled biomass with the influent wastewater; and basing biomass recycle rate on: (1) influent water quality determined by grab sampling or (2) offline monitoring of induced biomass respiration rate.

11. The method of claim 1 including producing a biomass having the capacity to accumulate more than 30 g-PHA per 100 g-biomass volatile solids.

12. The method of claim 1 including producing a biomass having the capacity to accumulate more than 40 g-PHA per 100 g-biomass volatile solids.

13. The method of claim 1 including maintaining solids residence time of the biomass to less than two days.

14. The method of claim 1 including maintaining solids residence time of the biomass to less than four days.

15. The method of claim 1 including separating particulate organic matter from the wastewater and fermenting the separated particular organic matter and wherein RBCOD produced by the fermentation of the separated particular organic matter is used to enhance the feast conditions or used after harvesting biomass to supply RBCOD for PHA production.

16. The method of claim 1 wherein enhancing the PHA accumulation potential of the biomass further comprises two or more of the following:
a. maintaining the average peak concentration of RBCOD available to the biomass during feast conditions at 10 mg-COD\L-2000 mg-COD\L;
b. providing wastewater that includes a volumetric organic loading rate equal to or greater than 2 kg-RBCOD\M³\day;
c. separating biomass from the wastewater and recycling the separated biomass and mixing the biomass with influent wastewater such that the volumetric mixing ratio of wastewater to recycled biomass is approximately 0.1 to approximately 5.0; and
d. maintaining solids residence time of the biomass to less than four days.

17. The method of claim 16 including producing biomass having the capacity to accumulate more than 30 g-PHA per 100 g-biomass volatile solids.

18. The method of claim 17 including providing wastewater wherein at least 75% of the RBCOD in the wastewater comprises on average compounds other than volatile fatty acids and alcohols.

19. The method of claim 16 wherein the feast conditions are present in a feast zone and wherein the method further includes generally maintaining the dissolved oxygen concentration in the feast zone at greater than 0.5 mg\0₂\L.

20. The method of claim 16 wherein enhancing the PHA accumulation potential of the biomass further comprises steps a, b, c, and d.

21. The method of claim 20 further including:
a. producing biomass having the capacity to accumulate more than 30 g-PHA per 100 g-biomass volatile solids;
b. providing wastewater wherein at least 75% of the RBCOD in the wastewater comprises on average compounds other than volatile fatty acids and alcohols; and
c. wherein the feast conditions are present in a feast zone and wherein the method further includes generally maintaining the dissolved oxygen concentration in the feast zone at greater than 0.5 mg\0₂\L.

22. A method of treating influent wastewater and producing a mixed culture biomass with enhanced PHA accumulation potential, the method comprising:
a. directing the influent wastewater containing RBCOD into a wastewater treatment system;
b. producing a biomass and utilizing the biomass to biologically treat the wastewater and remove contaminants therefrom;
c. enhancing the PHA accumulation potential of the biomass by:
1. subjecting the biomass to alternating feast and famine conditions within the wastewater treatment system and wherein in at least one instance the biomass is subjected to famine conditions before being subjected to feast conditions; and
2. stimulating the biomass to feast on the RBCOD by subjecting the biomass to feast conditions that cause the biomass to reach a peak respiration rate that is at least 40% of the extant maximum respiration rate for the biomass.

23. The method of claim 22 wherein biologically treating the wastewater produces a sludge and wherein PHA accumulation potential in the biomass is further enhanced by controlling sludge retention time and RBCOD loading.

24. The method of claim 22 further including enhancing PHA accumulation potential of the biomass by subjecting the biomass to feast conditions where the peak RBCOD concentration of mixed liquor is at least 10 mg-COD/L.

25. The method of claim 22 wherein volumetric organic loading rate based on RBCOD is equal to or greater than 2 kg-COD/m³/day.

26. The method of claim 22 further including providing influent wastewater where on average 25% or less of the RBCOD is comprised of VFAs and alcohols.

27. The method of claim 22 wherein the wastewater is fed continuously or in fed batch, and wherein feast conditions are stimulated by premixing the biomass with influent wastewater in order to establish feast stimulating conditions.

28. The method of claim 26 wherein the biomass is separated from the wastewater and recycled for mixing with the influent wastewater; and wherein the influent wastewater to recycled biomass volumetric mixing ratio is between 0.1 and 5.0.

29. The method of claim 22 including supplying the oxygen to the biomass being subjected to feast conditions such that the average dissolved oxygen concentration is greater than 0.5 mg-O₂/L.

30. The method of claim 22 including online monitoring of water quality of the influent wastewater or induced biomass respiration rate, and based on the online monitoring determining a mixing ratio or a range of mixing ratios for mixing the biomass with the influent wastewater.

31. The method of claim 22 including conducting grab sampling and offline batch monitoring of water quality of the influent wastewater or induced biomass respiration rate, and based on the grab sampling and offline batch monitoring determining a mixing ratio or range of mixing ratios for mixing the biomass with the influent wastewater.

32. The method of claim 22 including producing biomass and accumulating PHA therein and wherein the mass of the PHA accumulated in the biomass is greater than 30 g-PHA per 100 g-biomass volatile solids.

33. The method of claim 22 including producing biomass and accumulating PHA therein and wherein the mass of the PHA accumulated in the biomass is greater than 40 g-PHA per 100 g-biomass volatile solids.

34. The method of claim 22 including controlling solids residence time of the biomass to less than two days.

35. The method of claim 22 including controlling solids residence time of the biomass to less than four days.

36. The method of claim 22 including separating particulate organic matter from the influent wastewater upstream of feast treatment.

37. The method of claim 36 including fermenting the separated particulate organic matter and producing RBCOD by fermentation and utilizing the RBCOD produced through fermentation to enhance conditions of feast or to supply RBCOD for final PHA production in harvested biomass.

38. The method of claim 22 wherein enhancing the PHA accumulation potential of the biomass further comprises two or more of the following:
a. maintaining the average peak concentration of RBCOD available to the biomass during feast conditions at 10 mg-COD\L-2000 mg-COD\L;
b. providing wastewater that includes a volumetric organic loading rate equal to or greater than 2 kg-RBCOD\M³\day;
c. separating biomass from the wastewater and recycling the separated biomass and mixing the biomass with influent wastewater such that the volumetric mixing ratio of wastewater to recycled biomass is approximately 0.1 to approximately 5.0; and
d. maintaining solids residence time of the biomass to less than four days.

39. The method of claim 22 including producing biomass having the capacity to accumulate more than 30 g-PHA per 100 g-biomass volatile solids.

40. The method of claim 39 including providing wastewater wherein at least 75% of the RBCOD in the wastewater comprises compounds other than volatile fatty acids and alcohols.

41. The method of claim 22 wherein the feast conditions are present in a feast zone and wherein the method further includes generally maintaining the dissolved oxygen concentration in the feast zone at greater than 0.5 mg\0₂\L.

42. The method of claim 22 wherein enhancing the PHA accumulation potential of the biomass further comprises steps a, b, c, and d.

43. The method of claim 42 further including:
a. producing biomass having the capacity to accumulate more than 30 g-PHA per 100 g-biomass volatile solids;
b. providing wastewater wherein at least 75% of the RBCOD in the wastewater comprises compounds other than volatile fatty acids and alcohols; and
c. wherein the feast conditions are present in a feast zone and wherein the method further includes generally maintaining the dissolved oxygen concentration in the feast zone at greater than 0.5 mg\0₂\L.
